(19) United States
(12) Patent Application Publication
(10) Pub. No.: US 2026/0046472 A1
(43) Pub. Date: Feb. 12, 2026

(54) DISPLAY DRIVING APPARATUS, AND DISPLAY APPARATUS HAVING THE SAME

(71) Applicant: SAMSUNG ELECTRONICS CO., LTD., Suwon-si (KR)

(72) Inventors: Taehong Kim, Suwon-si (KR); Joohee Choi, Suwon-si (KR); Dayoung Kim, Suwon-si (KR); Soyoung Shin, Suwon-si (KR)

(21) Appl. No.: 19/060,406

(22) Filed: Feb. 21, 2025

(30) Foreign Application Priority Data
Aug. 12, 2024 (KR) 10-2024-0107272

(51) Int. Cl. H04N 21/431; H04N 21/81

(52) U.S. Cl. CPC H04N 21/4312; H04N 21/8146

(57) ABSTRACT

A display apparatus includes: a video processing unit processing a video signal; a graphics processing unit processing a graphics signal; a mixing unit mixing video corresponding to the processed video signal and graphics corresponding to the processed graphics signal; a display unit outputting the mixed video and graphics; and a main processing unit configured to control the video processing unit, the graphics processing unit, the mixing unit and the display unit.

### CROSS-REFERENCE TO RELATED APPLICATION(S)

This application claims benefit of Korean Patent Application No. 10-2024-0107272 filed in the Korean Intellectual Property Office on Aug. 12, 2024, the disclosure of which is incorporated herein by reference in its entirety.

### BACKGROUND

A display apparatus provided with a display unit such as a television (TV) may receive various contents provided from an external source and may output images to a display unit based thereon. As various video services using a network environment become popular, a content including additional images such as graphics may be provided. The display apparatus may include an additional processing unit processing a video signal and a graphics signal, respectively, and may be implemented in a form in which the two processed signals are mixed to output an image. Since the video signal and graphics signal are processed through different paths, a video frame and a graphics frame may not match each other. Accordingly, noise may occur in the output image, which may cause inconvenience to users while viewing the output image.

### SUMMARY

In general, the present disclosure is directed toward a display apparatus for synchronizing and outputting a video frame and a graphics frame.

According to some implementations, the present disclosure is directed to a display apparatus that includes: a video processing unit processing a video signal; a graphics processing unit processing a graphics signal; a mixing unit mixing video corresponding to the processed video signal and graphics corresponding to the processed graphics signal; a display unit outputting the mixed video and graphics; and a main processing unit configured to control the video processing unit, the graphics processing unit, the mixing unit and the display unit, and the video signal includes a plurality of video frames, and the graphics signal includes a plurality of graphics frames, and the main processing unit is configured to calculate a video delay time for each of the plurality of video frames, using a video rendering request time at which rendering is requested for each of the plurality of video frames and a video output time at which each of the plurality of video frames is output to the display unit, calculate a graphics delay time for each of the plurality of graphics frames, using a graphics rendering request time at which rendering is requested for each of the plurality of graphics frames and a graphics output time at which each of the plurality of graphics frames is output to the display unit, and synchronize the plurality of video frames and the plurality of graphics frames by compensating at least one of the video delay time and the graphics delay time.

According to some implementations, the present disclosure is directed to a display apparatus that includes: a video processing unit processing a video signal including a plurality of video frames and including a plurality of video processing components; a graphics processing unit processing a graphics signal including a plurality of graphics frames and including a plurality of graphics processing components; a mixing unit mixing video corresponding to the processed video signal and graphics corresponding to the processed graphics signal; a display unit outputting the mixed video and graphics; and a main processing unit configured to control the video processing unit, the graphics processing unit, the mixing unit and the display unit, and the number of the plurality of video processing components is greater than the number of the plurality of graphics processing components, and the main processing unit is configured to shorten a video delay time from a time at which rendering is requested for each of the plurality of video frames to a time at which each of the plurality of video frames is output to the display unit, and extend a graphics delay time from a time at which rendering is requested for each of the plurality of graphics frames to a time at which each of the plurality of graphics frames is output to the display unit.

According to some implementations, the present disclosure is directed to a display driving apparatus that includes: a first semiconductor chip including a first video processing unit processing a video signal including a plurality of video frames, a first graphics processing unit processing a graphics signal including a plurality of graphics frames, a first main processing unit configured to control the first video processing unit and the first graphics processing unit, and a first memory unit including a first video buffer for storing the processed video signal and a first graphics buffer for storing the processed graphics signal; and a second semiconductor chip including a second video processing unit processing the processed video signal, a second graphics processing unit processing the processed graphics signal, a second main processing unit configured to control the second video processing unit and the second graphics processing unit, and a second memory unit including a second video buffer for storing the processed video signal and a second graphics buffer for storing the processed graphics signal, and the first main processing unit is configured to calculate a video delay time from a time at which rendering is requested for each of the plurality of video frames to a time at which each of the plurality of video frames is output, and calculate a graphics delay time at a time which rendering is requested for each of the plurality of graphics frames to a time at which each of the plurality of graphics frames is output, and the first main processing unit and the second main processing unit are configured to shorten the video delay time by omitting at least portions of a plurality of first video processing components included in the first video processing unit and a plurality of second video processing components included in the second video processing unit, or extend the graphics delay time by adding a graphics buffer to at least one of the first graphics buffer and the second graphics buffer.

According to some implementations, the present disclosure is directed to processing of a delay time of a video signal by a video processing unit of a display apparatus and a delay time of a graphics signal by a graphics processing unit that may be controlled to be identical to each other, so that the video signal and the graphics signal may be synchronized and output. Accordingly, noise occurring in the output image may be reduced.

### BRIEF DESCRIPTION OF DRAWINGS

Example implementations will be more clearly understood from the following detailed description, taken in conjunction with the accompanying drawings.

FIG. 1 is a view illustrating an example of a display apparatus according to some implementations.

FIG. 2 is a view illustrating an example in which geometry of video and a graphics are changed simultaneously in a display apparatus according to some implementations.

FIG. 3 is a block diagram illustrating an example of a configuration of a display apparatus according to some implementations.

FIG. 4 is a block diagram schematically illustrating examples of software and hardware for outputting an image in a display apparatus according to some implementations.

FIG. 5 is a block diagram illustrating an example of a configuration of the hardware illustrated in FIG. 4 according to some implementations.

FIG. 6 is a flowchart illustrating an example of an operation for controlling video and a graphics to be synchronized and output in a display apparatus according to some implementations.

FIG. 7 is a flowchart illustrating an example of a process of calculating a video delay time and a graphics delay time according to some implementations.

FIG. 8 is a flowchart illustrating an example of a process of calculating a video delay time and a graphics delay time according to some implementations.

FIG. 9 is a flowchart illustrating an example of a process of compensating a video delay time according to some implementations.

FIG. 10 is a flowchart illustrating an example of a process of compensating a video delay time according to some implementations.

FIG. 11 is a flow chart illustrating an example process of compensating a graphics delay time according to some implementations.

FIGS. 12 to 14 are views illustrating examples of a vertical synchronization signal, a video signal, and a graphics signal according to some implementations.

FIG. 15 is a block diagram schematically illustrating an example configuration of a display apparatus according to some implementations.

### DETAILED DESCRIPTION

Hereinafter, example implementations will be explained in detail with reference to the accompanying drawings.

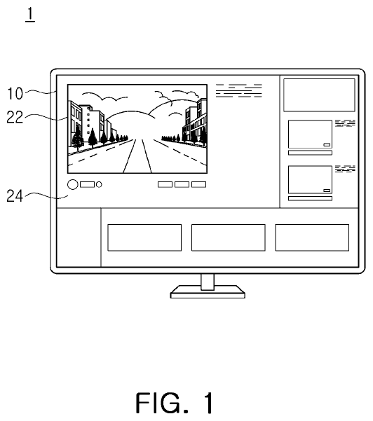

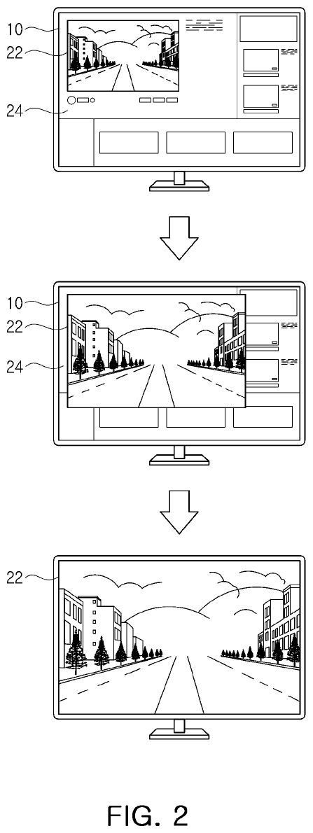

FIG. 1 is a view illustrating an example of a display apparatus according to some implementations. FIG. 2 is a view illustrating an example in which geometry of video and a graphics are changed simultaneously in a display apparatus according to some implementations.

In FIG. 1, a display apparatus 1 may be implemented as a display apparatus including a display unit 10. The display apparatus 1 may receive data regarding a content from an external signal source, and may process data of the received content according to a preset process to output the data as an image on the display unit 10.

In some implementations, the display apparatus 1 implemented as a display apparatus may be implemented as a television (TV) capable of processing a broadcast image based on at least one of a broadcast signal, broadcast information, or broadcast data received from transmission equipment of a broadcasting station. In this case, the display apparatus 1 may be provided with a tuner for tuning the broadcast signal for each channel.

The display apparatus 1 may be an image processing device such as a set-top box transmitting a signal to an external display unit connected by wire or wirelessly. The display apparatus 1 may be a terminal apparatus provided with a display unit, including a smartphone or a smart pad such as a tablet. Additionally, the display apparatus 1 may be a monitor of a personal computer (PC) such as a desktop or laptop.

When the display apparatus 1 is a television, the display apparatus 1 may receive a broadcast content based on at least one of a broadcast signal, broadcast information, and broadcast data received from transmission equipment of a broadcasting station directly or through an additional device that may be connected to the display apparatus 1 by a cable, or the like. The additional device may correspond to a set-top box (STB), an OC box (one-connect box), a media box, or the like. A wired or wireless interface such as a cable may be applied as a connection method between the display apparatus 1 and the additional device.

The display apparatus 1 may wirelessly receive the broadcast content, which is a radio frequency (RF) signal transmitted from the broadcasting station. To this end, the display apparatus 1 may include an antenna capable of receiving broadcast signals. However, a signal supply source of the display apparatus 1 is not limited to the broadcasting station, and the broadcast content may be received through terrestrial waves, cables, or satellites.

The standard of a signal received by the display apparatus 1 may be configured in various manners in response to the implementation form of the apparatus. The display apparatus 1 may receive signals corresponding to the standards of High Definition Multimedia Interface (HDMI), Consumer Electronics Control (HDMI-CFC), display port (DP), DVI, composite video, component video, super video, Digital Visual Interface (DVI), Thunderbolt, an RGB cable, Syndicat des Constructeurs d'Appareils Radiorecepteurs et Televiseurs (SCART), a universal serial bus (USB), or the like, as video contents by wire.

In some implementations, the display apparatus 1 may be implemented as a smart TV or Internet Protocol TV (IP TV). Smart TV may receive and output broadcast signals in real time, and may have a web browsing function, thereby providing a user environment in which various contents may be searched and consumed via the Internet at the same time as an output of real-time broadcast signals. Additionally, the smart TV may include an open software platform, thereby providing interactive services to a user. Accordingly, the smart TV may provide contents of applications that provide various services to the user through an open-type software platform. Such applications are application programs that may provide various types of services, and include applications that provide services, such as SNS, finance, news, weather, maps, music, movies, games, and e-books.

The display apparatus 1 may process signals to output moving images, still images, applications, on-screen display (OSD), and user interfaces (UI) for various operation control, on the screen, based on signals/data stored in internal/external storage media.

The display apparatus 1 is a source for providing contents, and may receive contents from various external apparatuses including servers and terminal devices, through wired or wireless network communication, and the type of communication is not limited.

Specifically, the display apparatus 1 may receive signals corresponding to standards, such as Wi-Fi, Wi-Fi Direct, Bluetooth™, Bluetooth™ low energy, Zigbee™, Ultra-Wideband (UWB), and Near Field Communication (NFC), as a video content, through wireless network communication, in response to the implementation form of an interface unit 120 described below. Additionally, the display apparatus 1 may receive content signals through wired network communication such as Ethernet.

In some implementations, an external apparatus may be provided as a content provider, i.e., a content server, which may transmit content to various devices including the display apparatus 1 through a wired or wireless network. For example, the external apparatus may provide media files, such as video on demand (VOD) or a web content, in a real-time streaming manner.

In some implementations, a plurality of external apparatuses may be included. In this case, the display apparatus 1 may be connected to each of the plurality of external apparatuses and may be implemented to receive various contents from each of the connected external apparatuses.

The display apparatus 1 may receive video contents, such as VOD or media contents, from a web server such as YouTube or an over the top (OTT) service, such as Netflix.

The display apparatus 1 may execute an application for content playback, for example, a VOD application, and may receive contents from an external apparatus provided for content provision and processes the received contents, thereby outputting an image corresponding to the contents through the display unit 10. Here, the display apparatus 1 may receive contents from the external apparatus using a user account corresponding to the executed application.

In some implementations, the display apparatus 1 may output video 22 and graphics 24 together on the display unit 10, as illustrated in FIG. 1. Specifically, the display apparatus 1 may receive a video signal corresponding to the video 22 and a graphics signal corresponding to the graphics 24, and may process the received video signal and the received graphics signal, respectively. The display apparatus 1 may mix the video signal and the graphics signal processed through a separate path, so that the video 22 and the graphics 24 may be output together on the display unit 10.

The graphics signal may include a signal for outputting information, such as a subpicture, a subtitle, a teletext, on-screen display (OSD) output for delivering information, such as channel numbers and program titles, to the user or for various operation control, or a user interface (UI). However, the present disclosure may not be limited thereto.

The graphics signal may be included in a content provided from an external apparatus such as a server, may be provided from the external apparatus as a separate signal separated from the content. Here, the external apparatus providing the content and the external apparatus providing the graphics signal may be the same or different from each other. Additionally, the graphics signal may be built into an additional device, such as the display apparatus 1 or a set-top box. In some implementations, the graphics signal may be formed of a plurality of layers.

In some implementations, the display apparatus 1 may output interactive graphics (IG) or presentation graphics (PG) generated by processing graphics signals as a graphics to the display unit 10.

In some implementations, the video 22 may be overlaid with the graphics 24 and may be output onto the display unit 10. The video 22 may be output in a separate region separated from a region in which the graphics 24 is output.

In FIG. 2, in a state in which the video 22 and the graphics 24 are simultaneously output to the display unit 10, a region of the video 22 may be gradually expanded. At this time, the time required for the video 22 to be output to the display unit 10 may be longer than the time required for the graphics 24 to be output to the display unit 10.

A general display apparatus 1 may be controlled by extending the time required for the graphics 24 to be output to the display unit 10. However, due to the resolution, size, position, and the like, of the video 22, the video 22 and the graphics 24 may not match each other, which may cause noise.

The display apparatus 1 may control the time required for the video 22 and the graphics 24 to be output to the display unit 10 to be the same. Accordingly, the video 22 and the graphics 24 may be synchronized and output to the display unit 10, which may reduce noise.

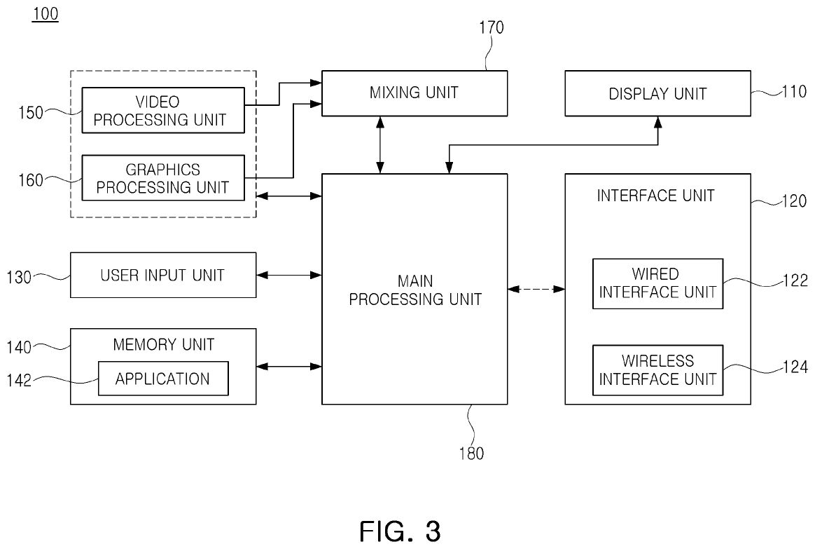

FIG. 3 is a block diagram illustrating an example of a configuration of a display apparatus according to some implementations. In FIG. 3, a display apparatus 100 may include a display 110, an interface unit 120, a user input unit 130, a memory unit 140, a video processing unit 150, a graphics processing unit 160, a mixing unit 170, and a main processing unit 180.

The display unit 110 may display an image. An implementation manner of the display unit 110 may be implemented in the form of a liquid crystal, a plasma, a light-emitting diode, an organic light-emitting diode, a surface-conduction electron-emitter, a carbon nano-tube, a nano-crystal, or the like.

In some implementations, the display unit 110 may output an image of content received from an external apparatus, such as a server. In an example embodiment, the display unit 110 may output a video based on a video signal and a graphics based on a graphics signal together. In some implementations, the video may be output on the display unit 110 while overlapping the graphic. The video may be output in a separate region separated from a region in which the graphics is output.

The interface unit 120 allows the display apparatus 100 to communicate with various external apparatuses including a server. The interface unit 120 may include a wired interface unit 122 and a wireless interface unit 124.

The wired interface unit 122 may include a connection unit that transmits/receives signals/data according to standards, such as HDMI, HDMI-CFC, USB, Component, Display Port (DP), DVI, Thunderbolt, and RGB cables. The wired interface unit 122 may include at least one connector, at least one terminal, or at least one port corresponding to each of these standards.

The wired interface unit 122 is implemented in a form that includes an input port receiving a signal from a source, or the like, and may be provided to enable bidirectional signal transmission and reception by further including an output port in some cases.

The wired interface unit 122 may be connected to an antenna that may receive broadcast signals according to broadcast standards, such as terrestrial/satellite broadcasting. In some implementations, the wired interface unit 122 may include a connector or a port according to a video and/or audio transmission standard, such as an HDMI port, a DisplayPort, a DVI port, Thunderbolt, composite video, component video, super video, SCART, or the like, so that a cable may be connected thereto.

When the display apparatus 1 receives a broadcast signal through the interface unit 120, the display apparatus 1 may further include a tuner that tunes the received broadcast signal by channel. The tuner may include a demodulator that demodulates the broadcast signal of a tuned specific channel and outputs the broadcast signal as a signal in the form of a transport stream (TS). In other words, the tuner and the demodulator may be designed as a single chip in an integrated form, or may be implemented as two chips that are separated from each other.

The wired interface unit 122 may include a connector or a port according to a universal data transmission standard, such as a USB port. The wired interface unit 122 may include a connector or a port, such as a connector or a port to which an optical cable may be connected, according to an optical transmission standard. The wired interface unit 122 may include a connector or a port to which an external microphone or an external audio device provided with a microphone is connected, and may receive or input audio signals from the microphone or the audio device.

The wired interface unit 122 may include a connector or a port to which an audio device, such as a headset, an earphone, or an external speaker, may be connected, and which may transmit or output audio signals to the audio device. The wired interface unit 122 may include a connector or a port according to a network transmission standard, such as Ethernet. For example, the wired interface unit 122 may be implemented as a LAN card or the like, connected to a router or a gateway in a wired manner.

The wired interface unit 122 may be connected, in a wired manner, to an external apparatus, such as a set-top box, an optical media player, or an external display apparatus, a speaker, a server, or the like, in a 1:1 or 1:N (where N is a natural number) manner, thereby receiving video/audio signals from the external apparatus or transmitting video/audio signals to the external apparatus. The wired interface unit 122 may include a connector or a port that separately transmits video/audio signals, respectively.

The wired interface unit 122 may be implemented as a communication circuitry including a wireless communication module (S/W module, chip, and the like) corresponding to various types of communication protocols. In some implementations, the wired interface unit 122 may be built into the display apparatus 100, but may also be implemented in the form of a dongle or module and may be detachable from a connector of the display apparatus 100.

The wireless interface unit 124 may be implemented in various manners corresponding to the implementation form of the display apparatus 100. For example, the wireless interface unit 124 may use wireless communication, such as radio frequency (RF), Zigbee, Bluetooth, Wi-Fi, Ultra WideBand (UWB), and Near Field Communication (NFC), as a communication method.

The wireless interface unit 124 may be implemented as a communication circuitry including a wireless communication module (S/W module, chip, and the like) corresponding to various types of communication protocols. In some implementations, the wireless interface unit 124 may include a wireless LAN unit. The wireless LAN unit may be wirelessly connected to an external apparatus through an access point (AP) under the control of the main processing unit 180. The wireless LAN unit includes a Wi-Fi module.

In some implementations, the wireless interface unit 124 includes a wireless communication module that supports one-to-one direct communication between the display apparatus 100 and the external apparatus without an access point. The wireless communication module may be implemented to support communication methods, such as Wi-Fi Direct, Bluetooth, and Bluetooth Low Energy. When the display apparatus 100 performs direct communication with the external apparatus, the memory unit 140 may store identification information, such as a MAC address and IP address, for the external apparatus, which is a communication target device.

In the display apparatus 100, the wireless interface unit 124 is provided to perform wireless communication with the external apparatus by at least one of a wireless LAN unit and a wireless communication module according to performance. In some implementations, the wireless interface unit 124 may further include a communication module by various communication methods, such as mobile communication, such as an LTE, EM communication including a magnetic field, and visible light communication.

The wireless interface unit 124 may wirelessly communicate with the external apparatus such as a server on a network, thereby transmitting or receiving data packets to or from the external apparatus.

The wireless interface unit 124 may include an IR transmitter and/or IR receiver that may transmit and/or receive Infrared (IR) signals according to an infrared communication standard. The wireless interface unit 124 may receive or input a remote control signal from a remote control or another external apparatus through the IR transmitter and/or IR receiver, or may transmit or output a remote control signal to another external apparatus. As another example, the display apparatus 100 may transmit and receive remote control signals with a remote control or other external apparatuses through a wireless interface unit 124 having another manner, such as Wi-Fi or Bluetooth.

In some implementations, the wireless interface unit 124 may transmit predetermined data as information of a user's voice received through a voice input unit such as a microphone to an external apparatus such as a server. Here, the form/type of the data transmitted is not limited, and for example, the data may include an audio signal corresponding to a voice spoken by the user, or a voice feature extracted from the audio signal.

Additionally, the wireless interface unit 124 may receive data of a processing result of the user's voice from an external apparatus such as a server. The display apparatus 100 may output a sound corresponding to a voice processing result through an internal or external speaker based on the received data. In some implementations, the user's voice may be processed by itself in the display apparatus 100 without being transmitted to the server. That is, in some implementations, the display apparatus 100 may be implemented to perform a role of a speech to text (STT) server.

The display apparatus 100 may communicate with an input apparatus, such as a remote control, through the wireless interface unit 124, thereby receiving a sound signal corresponding to the user's voice from the input apparatus.

In some implementations, a communication module communicating with an external apparatus, such as a server and a communication module communicating with the remote control may be different from each other. For example, the display apparatus 100 may perform communication with the external apparatus through an Ethernet modem or a Wi-Fi module, and may perform communication through a remote control and a Bluetooth module.

In some implementations, a communication module communicating with the external apparatus, such as a server and a communication module communicating with the remote control may be identical to each other. For example, the display apparatus 100 may perform communication with the external apparatus and the remote control through a Bluetooth module.

In some implementations, the wireless interface unit 124 may be built into the display apparatus 100, but may also be implemented in the form of a dongle or module and may be detachable from the connector of the display apparatus 100.

In some implementations, the display apparatus 100 may receive a broadcast signal through the interface unit 120. The display apparatus 100 may extract or generate a video signal corresponding to video and a graphics signal corresponding to a graphics based on the data included in the broadcast signal.

In some implementations, the display apparatus 100 may receive a content signal in real-time streaming mode from the external apparatus such as a server through the interface unit 120. The display apparatus 100 may extract or generate the video signal corresponding to the video and the graphics signal corresponding to the graphics based on the content signal.

The user input unit 130 may transmit various preset various control commands or unlimited information to the main processing unit 180 by the user's input. The user input unit 130 includes various input means capable of receiving a user input. In some implementations, the user input unit 130 may include a keypad including buttons, such as a power key, a number key, and a menu key, provided on the display apparatus 100.

In some implementations, the user input unit 130 may include an input apparatus for generating preset commands/data/information/signals so that the display apparatus 100 may be remotely controlled and transmitting the commands/data/information/signals to the display apparatus 100. The input apparatus may include, for example, a remote control, a game console, a keyboard, a mouse, and may receive the user input by being separated from the display apparatus 100.

The remote control may be provided with at least one button capable of receiving the user input. In some implementations, the remote control may be provided with a touch detection unit receiving the user's touch input and/or a motion detection unit detecting a movement of the remote control itself by the user. In some implementations, the input apparatus may include a terminal apparatus, such as a smartphone on which a remote control application is installed, and in this case, the user's touch input through a touch screen may be received.

The input apparatus is an external apparatus capable of wireless communication with a main body of the display apparatus 100, and the wireless communication includes Bluetooth, infrared communication, RF communication, wireless LAN, and Wi-Fi Direct.

In some implementations, the user input unit 130 may include a voice input unit receiving a voice/sound spoken by the user. The voice input unit may be implemented as a microphone capable of receiving the user's voice, and the microphone may be provided in the display apparatus 100, provided separately from the display apparatus 100, or provided in another device separated from the display apparatus 100, such as a remote control.

In some implementations, the user input unit 130 may include a motion detection unit detecting a movement of the user's hand, that is, a hand gesture. The motion detection unit of the display apparatus 100 may detect a movement distance of the hand, the movement speed, an area of a movement region, and the like, and may output data.

The memory unit 140 may be configured to store various data of the display apparatus 100. The memory unit 140 may have data remaining even when the power supplied to the display apparatus 100 is blocked, and may be provided with a writable nonvolatile memory (writable ROM) so that changes may be reflected therein. That is, the memory unit 140 may be provided with one of flash memory, EPROM, or EEPROM. The memory unit 140 may further include a volatile memory such as DRAM or SRAM, which has a faster read or write speed of the display apparatus 100 than the nonvolatile memory.

The data stored in the memory unit 140 includes, for example, an operating system for driving the display apparatus 100, and further includes various programs executable on the operating system, an application 142, image data, and additional data.

Specifically, the memory unit 140 may store signals or data input/output in response to the operation of each component according to the control of the main processing unit 180. The memory unit 140 may store a control program for controlling the display apparatus 100, a UI related to an application provided by a manufacturer or downloaded from an external source, graphics or images for providing the UI, user information, documents, databases, or related data.

In some implementations, the memory unit 140 may store a TV application or a TV client as a program that allows the display apparatus 100 to operate as a television, and a VOD application as a program that allows contents received from the external apparatus such as a server to be played.

In some implementations, the video and a graphics output from the display apparatus 100 may be derived from data stored in a non-volatile memory unit 140, such as a flash memory, a hard disk, or the like. The memory unit 140 may be provided inside or outside the display apparatus 100, and when the memory unit 140 is provided outside, the memory unit 140 may be connected to the display apparatus 100 via a wired interface unit 121.

In some implementations, the memory unit 140, a ROM, or a RAM in the main processing unit 180, or a memory card capable of being installed in the display apparatus 100 may be included.

The video processing unit 150 may process a video signal, so that the video corresponding to the video signal may be output to the display unit 110. The display apparatus 100 may process the video signal through a video path via the video processing unit 150.

The graphics processing unit 160 may process a graphics signal, so that the graphics corresponding to the graphics signal may be output to the display unit 110. The display apparatus 100 may process the graphics signal through a graphics path via the graphics processing unit 160. The graphics path may be different from the video path.

The mixing unit 170 may merge the video signal and the graphics signal and output the video signal and the graphics signal to the display unit 110. Accordingly, the video corresponding to the video signal processed by the video processing unit 150 and the graphics corresponding to the graphics signal processed by the graphics processing unit 160 may be output together to the display unit 110.

In some implementations, the mixing unit 170 may be implemented as a hardware configuration, for example, a chip, and may finally output synchronized video frames and graphics frames to the display unit 110.

In some implementations, the mixing unit 170 may perform alpha blending for synthesizing video and a graphics based on transparency information indicative of a degree of transparency of the graphic. The transparency information may correspond to an alpha value. For example, the alpha value may be 8-bit data capable of distinguishing the degree of transparency from 0 to 255.

The mixing unit 170 may synthesize the video signal and the graphics signal by referring to the alpha value. An image in which alpha blending has been performed based on an alpha value in the mixing unit 170 may be output through the display unit 110. In this case, the image may include video and graphics.

Since the video signal and the graphics signal are merged by the mixing unit 170 and output to the display unit 110, the video and the graphics may be output on a single screen of the display unit 110.

The main processing unit 180 performs control for performing operations of all components of the display apparatus 100. The main processing unit 180 may include a control program enabling the execution of such control operations, a nonvolatile memory in which the control program is installed, a volatile memory such as a DRAM in which at least a portion of an installed control program is loaded, and at least one processor, such as a microprocessor, an application processor, or a central processing unit CPU, which executes the loaded control program.

A processor included in the main processing unit 180 may include a single core, a dual core, a triple core, a quad core, and a multiple of the cores. Additionally, the processor, the ROM, and the RAM may be interconnected through an internal bus.

In some implementations, a plurality of processors may be provided. For example, the display apparatus 100 may be provided with a separate sub-processor operating in a sleep mode in which only standby power is supplied and without operating as a display apparatus.

In some implementations, the main processing unit 180 may execute the application 142 to determine geometry information for expressing video and a graphics. The geometry information may include, as parameters for expressing video and a graphic, size information and position information of each of the video and the graphic. For example, the geometry information may include coordinate values (x, y, w, h).

The geometry information may include a start point and an end point. The video may be controlled to be output in a section between the start point and the end point. The graphics may include a plurality of planes, and each plane may be controlled to be output in the section between the start point and the end point.

In some implementations, the main processing unit 180 may be implemented as a form included in a main SoC (Main SoC) mounted on a PCB embedded in the display apparatus 100.

The time required for the video signal to be processed in the video processing unit 150 and for the video to be output to the display unit 110 may be longer than the time required for the graphics signal to be processed in the graphics processing unit 160 and for the graphics to be output to the display unit 110. In other words, a video path for processing the video signal may be longer than a graphics path for processing the graphics signal.

The display apparatus 100 may control the time required for the video and the graphics to be output to the display unit 110 to be identical. Accordingly, the video and the graphics may be synchronized and output to the display unit 110.

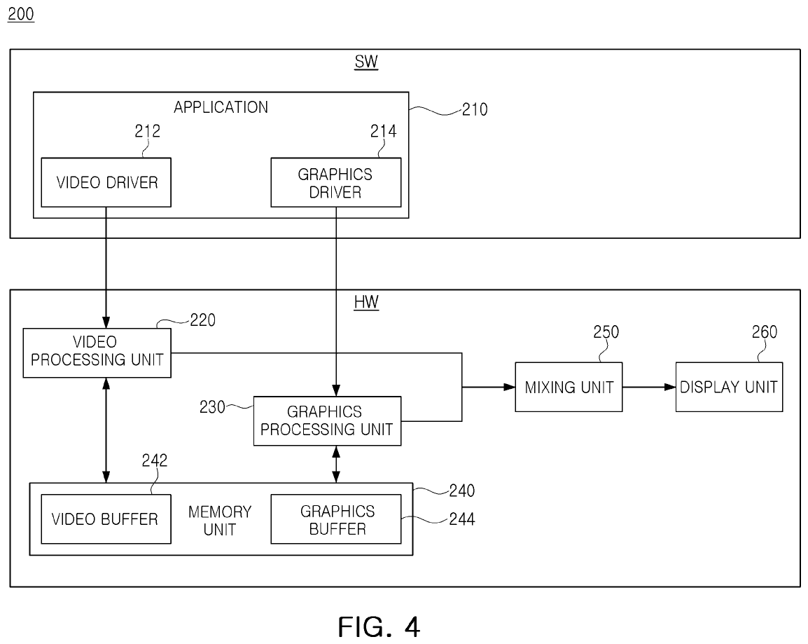

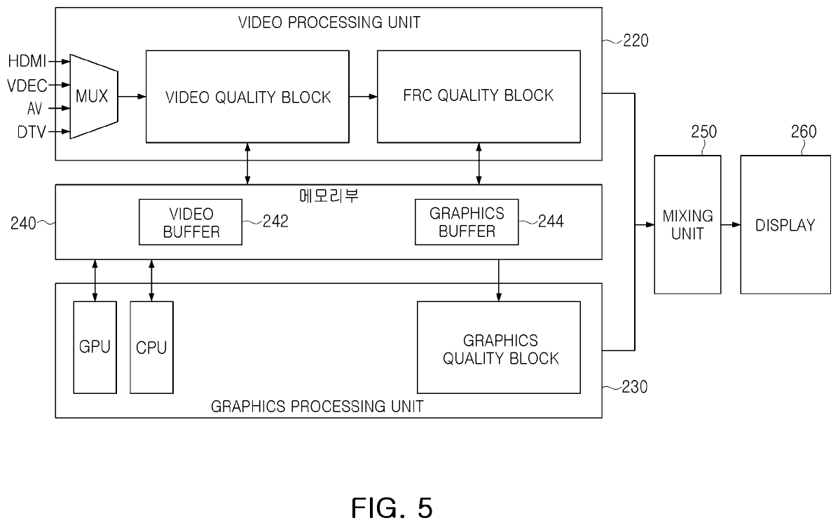

FIG. 4 is a block diagram schematically illustrating examples of software and hardware for outputting an image in a display apparatus according to some implementations. FIG. 5 is a block diagram illustrating an example configuration of the hardware illustrated in FIG. 4 according to some implementations.

In FIG. 4, a configuration of a display apparatus 200 may be divided into software (SW) and hardware (HW). In some implementations, the display apparatus 200 may be similar to those described above in FIGS. 1 to 3.

The software (SW) may include an application 210. The application 210 may include a video driver 212 and a graphics driver 214. In some implementations, the video driver 212 may be a video driver, and the graphics driver 214 may be a graphics driver. The hardware (HW) may include a video processing unit 220, a graphics processing unit 230, a memory unit 240, a mixing unit 250, and a display unit 260.

The application 210 may request rendering for video and a graphic.

The video driver 212 may set video geometry for expressing the video corresponding to the video signal, and may transmit video geometry information to the video processing unit 220. The video geometry information may include size information and position information for the video. Specifically, the video signal may include a plurality of video frames, and the video geometry information may include sizes and positions of each of the plurality of video frames.

In FIGS. 4 and 5, the video processing unit 220 may include a multiplexer (MUX), a video quality block, and an FRC quality block. Each of the video quality block and the FRC quality block may include at least one video processing configuration. That is, the video processing unit 220 may include a plurality of video processing components. The video path may correspond to a multiplexer (MUX) or an FRC quality block.

Signals output from HDMI, video decoder (VDEC), Audio-Visual (AV), Digital Television (DTV) may be input to the video processing unit 220. Specifically, the signals may be input to a multiplexer (MUX), and the multiplexer (MUX) may output one of the signals to the video quality block. In this case, one signal may correspond to a video signal, and the video signal may include a plurality of video frames.

The video quality block may perform quality processing of the input video signal. For example, the video quality block may include a plurality of video processing components, and the plurality of video processing components may perform different quality processing operations on the video signal.

The video quality block may standardize the video signal to satisfy required standard conditions. Additionally, the video quality block may scale the video signal based on first geometry information received from the video driver 212, and may write the video signal in the memory unit 240. Specifically, the plurality of video frames may be stored in a video buffer 242 included in the memory unit 240.

Additionally, the video quality block may perform an operation of reducing noise of the plurality of video frames stored in the video buffer 242 or processing a user-set image quality. The video quality block may output a video signal on which quality processing has been performed, to the FRC quality block.

The FRC quality block may perform frame rate conversion (FRC) of the video signal. For example, the FRC quality block may include a plurality of video processing components, and the plurality of video processing components may perform different frame rate conversion operations on the video signal. The FRC quality block may convert frames per second of the video image, and the video image with the frames per second converted may be output to the mixing unit 250.

In FIG. 4, the graphics driver 214 may set graphics geometry for expressing the graphics corresponding to the graphics signal, and may transmit graphics geometry information to the graphics processing unit 230. The graphics geometry information may include size information and position information for the graphic. Specifically, the graphics signal may include a plurality of graphics frames, and the graphics geometry information may include sizes and positions of each of the plurality of graphics frames.

In FIGS. 4 and 5, the graphics processing unit 230 may include a plurality of graphics processing components. The plurality of graphics processing components may include a graphics processing unit GPU, a central processing unit CPU, and a graphics quality block. The central processing unit CPU may correspond to a portion of the main processing unit 180 of FIG. 3. The graphics path may correspond to a graphics processing unit GPU or a graphics quality block.

The graphics processing unit GPU and the central processing unit CPU may form a plurality of planes to form graphics frames. The plurality of planes may include a primary plane and an overlay plane. The graphics processing unit GPU and the central processing unit CPU may set graphics data for forming the plurality of planes and store the graphics data in the memory unit 240 using the graphics geometry information received from the graphics driver 214. Specifically, the set graphics data may be stored in a graphics buffer 244.

The graphics quality block may output the plurality of planes included in a single graphics frame from the graphics buffer 244. The graphics quality block may combine the plurality of output planes into one graphics frame to improve the quality, and may thus output the frame to the mixing unit 250. The graphics quality block may include a plurality of graphics processing components, and the plurality of graphics processing components may perform different quality processing operations on the plane or the graphics frame.

The mixing unit 250 may mix the video frame provided from the video processing unit 220 and the graphics frame provided from the graphics processing unit 230 and output the mixed video and graphics frames to the display unit 260. Accordingly, the corresponding video frame and the corresponding graphics frame may be output together to the display unit 260.

The video path of the video processing unit 220 may be longer than the graphics path of the graphics processing unit 230. In other words, the time required for the video processing unit 220 to process the video may be longer than the time required for the graphics processing unit 230 to process the graphic. That is, a problem may occur in which the video and the graphics are not synchronized and output to the display unit 260.

In some implementations, the display apparatus 200 may control the time required for the video and the graphics to be output to the display unit 260 to be identical, so that the video and the graphics may be synchronized and output to the display unit 260.

In some implementations, when the video processing unit 220 processes the video signal, the time required for the video to be output to the display unit 260 may be shortened by omitting at least one of the plurality of video processing components included in the video processing unit 220, or implementing less than all of the plurality of video processing components. For example, at least one of the plurality of video processing components included in the video quality block and the FRC quality block may be omitted.

In some implementations, when the graphics processing unit 230 processes the graphics signal, the number of graphics buffers 244 may be increased to extend the time required for the graphics to be output to the display unit 260. For example, the number of graphics buffers 244 may be increased so that the time required for the graphics to be output to the display unit 260 may be identical to the time required for the video to be output to the display unit 260.

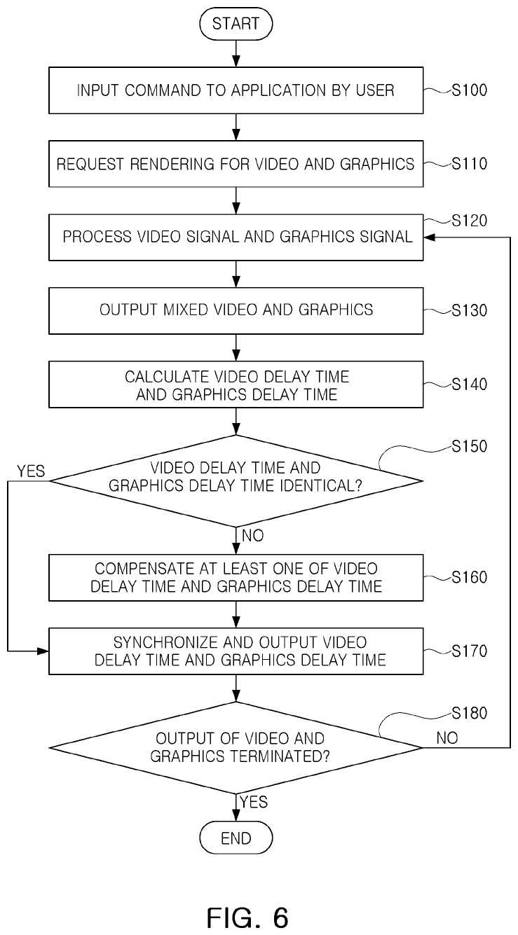

FIG. 6 is a flowchart illustrating an example of an operation for controlling video and a graphics to be synchronized and output in a display apparatus according to some implementations. In FIG. 6, the display apparatus may include a video processing unit, a graphics processing unit, a mixing unit, a display unit, a memory unit, and a main processing unit.

The video processing unit may process a video signal, and the graphics processing unit may process a graphics signal. The mixing unit may mix video corresponding to a processed video signal and a graphics corresponding to a processed graphics signal. The display unit may output the mixed video and graphics.

The memory unit may include a video buffer for storing the video signal processed by the video processing unit, and a graphics buffer for storing the graphics signal processed by the graphics processing unit. The main processing unit may control the video processing unit, the graphics processing unit, the mixing unit, the display unit and the memory unit. Additionally, the main processing unit may execute an application stored in the memory unit.

The video signal may include a plurality of video frames, and the graphics signal may include a plurality of graphics frames. In some implementations, the display apparatus may be similar to those described above in FIGS. 1 to 5. Hereinafter, an operation of a display apparatus for controlling the video and the graphics to be synchronized and output will be described.

A user may input a command to an application (S100). In FIG. 2, in the display apparatus in which the video and the graphics are currently output together, the user may input a command to switch the video to a full screen to an application.

According to the user's command, the application may request rendering for the video and the graphics (S110). In other words, the application may sequentially request rendering for video frames and graphics frames that should be synchronized and output.

The application may transmit video geometry information for the video to the video processing unit, and may transmit graphics geometry information for the graphics to the graphics processing unit. The video processing unit may process a video signal using the video geometry information, and the graphics processing unit may process a graphics signal using the graphics geometry information (S120).

Referring to FIG. 5, the video signal may be processed through a plurality of video processing components of the video processing unit. The graphics signal may be processed through the plurality of graphics processing components of the graphics processing unit. The video signal and the graphics signal may be processed frame for each frame according to a synchronization signal, and the synchronization signal may be a vertical synchronization signal for the display.

The video corresponding to the processed video signal and the graphics corresponding to the processed graphics signal may be mixed, and the mixed video and graphics may be output to the display unit (S130). In other words, based on the vertical synchronization signal for the display unit, the plurality of video frames included in the video signal and the plurality of graphics frames included in the graphics signal may be sequentially output.

The main processing unit may calculate the video delay time and the graphics delay time (S140). A video rendering request time at which rendering is requested for each of the plurality of video frames and a video output time at which each of the plurality of video frames is output to the display unit may be used to calculate the video delay time for each of the plurality of video frames. For example, the video delay time may be the time from the video rendering request time to the video output time.

A graphics rendering request time at which rendering is requested for each of the plurality of graphics frames and the graphics output time at which each of the plurality of graphics frames is output to the display unit may be used to calculate the graphics delay time for each of the plurality of graphics frames. For example, the graphics delay time may be the time from the graphics rendering request time to the graphics output time.

The main processing unit may determine whether the video delay time is identical to the graphics delay time (S150). When the video delay time and the graphics delay time are identical to each other (YES of S150), based on the vertical synchronization signal, the video frame and the graphics frame may be synchronized and sequentially output (S170).

When the video delay time and the graphics delay time are not identical to each other (NO of S150), the main processing unit may compensate at least one of the video delay time and the graphics delay time (S170). Since the video delay time and the graphics delay time are controlled identically, the video frame and the graphics frame may be synchronized and sequentially output based on the vertical synchronization signal (S170).

When an output of the video and the graphics is not terminated (NO of S180), processes of processing and outputting the video signal and the graphics signal, calculating the video delay time and the graphics delay time and synchronizing and outputting the video frame and the graphics frame (S120 to S170) may be repeatedly performed.

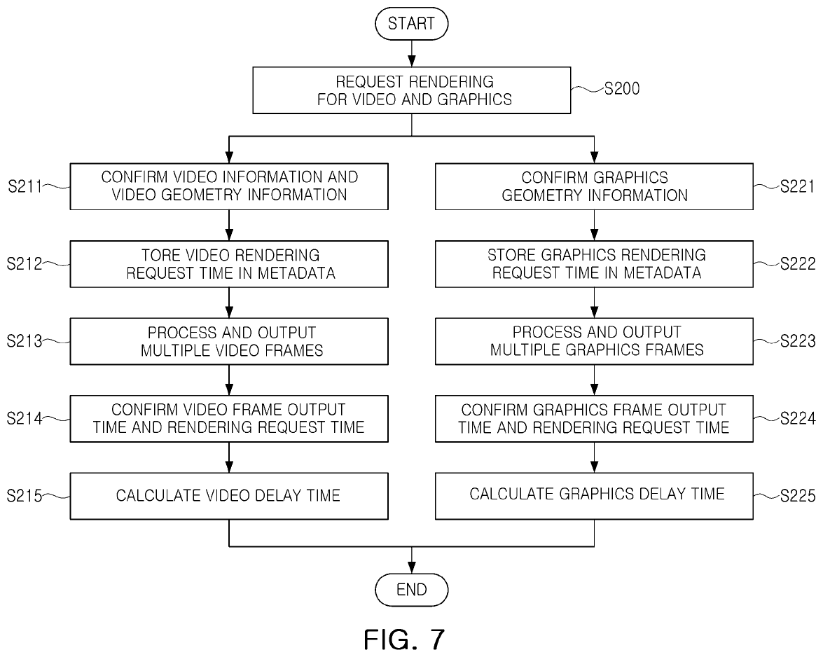

Hereinafter, the process of calculating the video delay time and the graphics delay time will be described in detail with reference to FIGS. 6 and 7.

FIG. 7 is a flowchart illustrating an example of a process of calculating video delay time and graphics delay time according to some implementations. In FIG. 7, according to a user's command, an application may request rendering for video and a graphics (S200). In this case, a process of calculating the video delay time may correspond to processes S211 to S215, and a process of calculating the graphics delay time may correspond to processes S221 to S225.

When the process of calculating the video delay time is described, the main processing unit may confirm video information and video geometry information (S211). The video information may include bits per pixel (BPP), frames per second (FPS), and resolution. The video geometry information may include sizes and positions of each of a plurality of video frames of the video. The geometry information may include coordinate values (x, y, w, h).

The main processing unit may store the video rendering request time at which rendering is requested for each of the plurality of video frames of the video signal in metadata (context data) (S212). For example, the video rendering request time may be stored in the metadata in the form of a timestamp.

The main processing unit may process and output the plurality of video frames (S213), and, in some implementations, may be similar to that described in the processes of S120 and S130 of FIG. 6 above.

The main processing unit may confirm a video frame output time and the video rendering request time for each of the plurality of video frames (S214). The main processing unit may calculate the video delay time using the video frame output time and the rendering request time (S215). Specifically, the video delay time may be the time from the video rendering request time to the video output time.

When the process of calculating the graphics delay time is described, the main processing unit may confirm graphics geometry information (S221). The graphics geometry information may include sizes and positions of each of the plurality of graphics frames of the graphic. The geometry information may include coordinate values (x, y, w, h).

The main processing unit may store the graphics rendering request time at which rendering is requested for each of the plurality of graphics frames of the graphics signal in the metadata (S222). For example, the video rendering request time may be stored in the metadata in the form of a timestamp.

The main processing unit may process and output the plurality of graphics frames (S223), and, in some implementations, may be similar to that described in the processes of S120 and S130 of FIG. 6 above.

The main processing unit may confirm the graphics frame output time and the graphics rendering request time for each of the plurality of graphics frames (S224). The main processing unit may calculate the graphics delay time using the graphics frame output time and the rendering request time (S225). Specifically, the graphics delay time may be the time from the graphics rendering request time to the graphics output time.

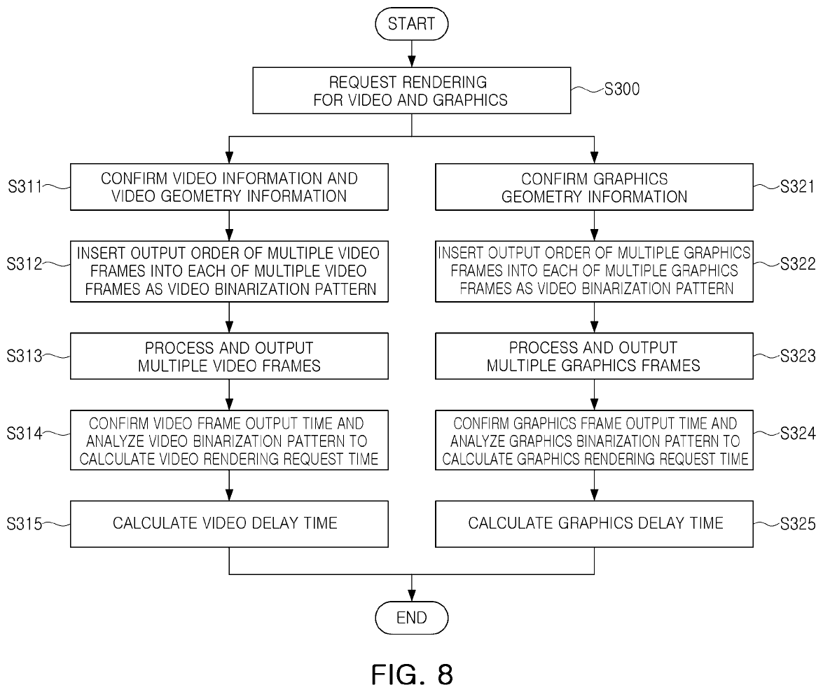

FIG. 8 is a flowchart illustrating an example of a process of calculating a video delay time and a graphics delay time according to some implementations. In terms of the video rendering request time and the graphics rendering request time, the implementations illustrated in FIGS. 7 and 8 differ from each other in that in the implementation illustrated in FIG. 7, the times may be stored in the metadata, whereas in the implementations illustrated in FIG. 8, the times may be calculated by analyzing a binarization pattern inserted into a frame.

According to the user's command, an application may request rendering for video and a graphics (S300). In this case, the process of calculating the video delay time corresponds to processes S311 to S315, and the process of calculating the graphics delay time corresponds to processes S321 to S325.

When the process of calculating the video delay time is described, the main processing unit may confirm the video information and the video geometry information (S311). The main processing unit may insert an output order of the plurality of video frames of the video signal into each of the plurality of video frames as a video binarization pattern (S312). Specific details of an operation of inserting the video binarization pattern into each of the plurality of video frames may be described in KR 2023-0056893, which is incorporated herein by reference.

The main processing unit may process and output the plurality of video frames (3213). For each of the plurality of video frames, the main processing unit may confirm the video frame output time and analyze the video binarization pattern to calculate the video rendering request time (S314). The main processing unit may calculate the video delay time using the video frame output time and the video rendering request time (S315). Specifically, the video delay time may be the time from the video rendering request time to the video output time.

When the process of calculating the graphics delay time is described, the main processing unit may confirm the graphics geometry information (S321). The main processing unit may insert an output order of the plurality of graphics frames of the graphics signal into each of the plurality of graphics frames as a graphics binarization pattern (S322). Specific details of an operation of inserting the binarization pattern into each of the plurality of video frames may be described in KR 2023-0056893, which is incorporated herein by reference.

The main processing unit may process and output the plurality of graphics frames (3223). For each of the plurality of graphics frames, the main processing unit may confirm the graphics frame output time, and may analyze the graphics binarization pattern to calculate the graphics rendering request time (S324). The main processing unit may calculate the video delay time using the graphics frame output time and the graphics rendering request time (S325). Specifically, the graphics delay time may be the time from the graphics rendering request time to the graphics output time.

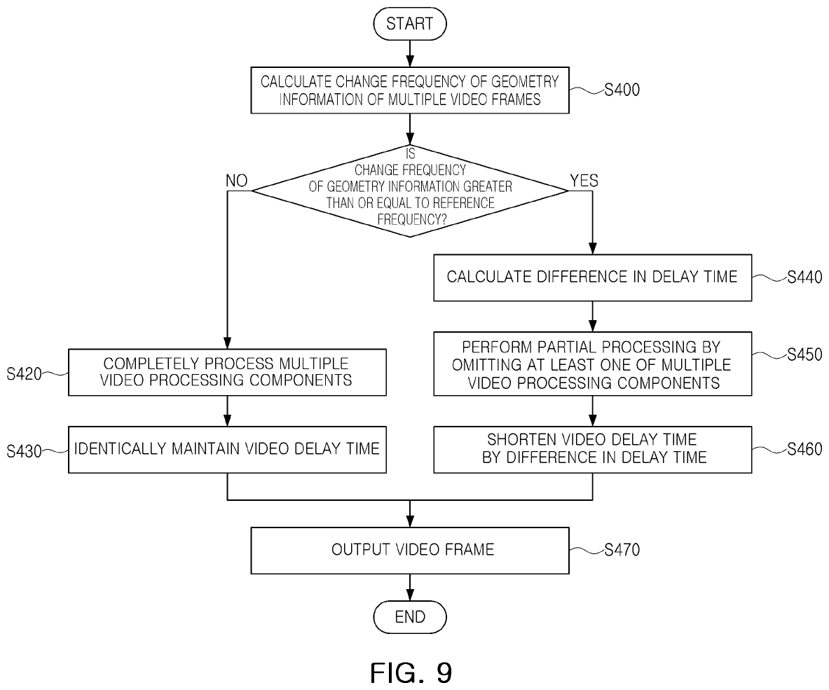

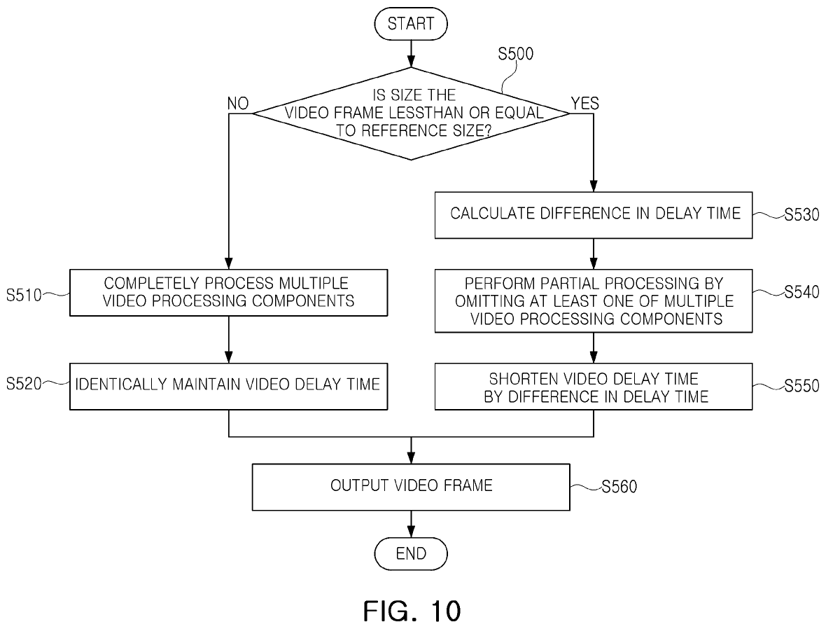

FIG. 9 is a flowchart illustrating an example of a process of compensating a video delay time according to some implementations. FIG. 10 is a flowchart illustrating an example of a process of compensating a video delay time according to some implementations.

In some implementations, a display apparatus may include a video processing unit, a graphics processing unit, a mixing unit, a display unit, a memory unit and a main processing unit. The video processing unit may include a plurality of video processing components, and the graphics processing unit may include a plurality of graphics processing components.

Referring to FIG. 5, the plurality of video processing components may include a multiplexer (MUX) or a frame rate converter (FRC). The plurality of graphics processing components may include a graphics processing unit GPU or a quality enhancement unit QE. The number of the plurality of video processing components may be greater than the number of the plurality of graphics processing components.

The video signal and the graphics signal may be processed for each frame according to a synchronization signal, and the synchronization signal may be a vertical synchronization signal for the display. Accordingly, since the video signal may be processed through more video processing components, the video delay time may be longer than the graphics delay time.

FIGS. 9 and 10 may correspond to examples of processes of shortening video delay time based on geometry information of the plurality of video frames. The geometry information may include sizes and positions of each of the plurality of video frames. In FIG. 9, an example of a process of compensating video delay time based on a change frequency of geometry information will be illustrated.

The main processing unit may calculate the change frequency of the geometry information of the plurality of video frames (S400). The change frequency of the geometry information may refer to the number of changes in a frame size or a frame position of a frame during a unit time. The change frequency of the geometry information may be included in the video information, may be calculated from the video information, or may be calculated by measuring the number of changes per unit time by a counter.

The main processing unit may determine whether the change frequency of the geometry information is greater than or equal to a reference frequency (S410). For example, the reference frequency may be a case in which the frame size or the frame position changes 10 times in 1 second.

When the change frequency of the geometry information is not greater than or equal to the reference frequency (NO of S410), the main processing unit may completely process the plurality of video processing components (S420). In other words, the video signal may be processed through all of the plurality of video processing components.

The video delay time may be identically maintained (S430), and the video frame may be output while maintaining the video delay time (S460). In other words, since a difference in delay time is maintained, the video and the graphics may be output without synchronization, which may cause noise.

When the change frequency of the geometry information is greater than or equal to the reference frequency (YES of S410), the main processing unit may calculate the difference in delay time, which is a difference between the video delay time and the graphics delay time (S440).

The main processing unit may perform partial processing by omitting at least one of the plurality of video processing components (S450). Referring to FIG. 5, the main processing unit may omit at least one of the plurality of video processing components included in the video quality block and the FRC quality block.

The omitted component may be determined by the difference in delay time, and frame delay required in the omitted component and the difference in delay time may be identical to each other. That is, video delay time may be shortened by the difference in delay time (S460). The video frame may be output at the shortened video delay time (S470). That is, since there is no difference in delay time, the video and a graphics may be synchronized and output.

The processes S400 to S470 may be repeatedly performed until an output of the video and the graphics is terminated.

In FIG. 10, an example of a process of compensating the video delay time based on the sizes of the plurality of video frames may be illustrated.

The main processing unit may determine whether the size of the video frame is less than or equal to the reference size (S500). For example, the reference size may correspond to half the size of the display unit. Specifically, a reference horizontal size may correspond to half the horizontal size of the display unit, and a reference vertical size may correspond to half the vertical size of the display unit.

When the size of the video frame is not less than or equal to the reference size (NO of S500), the main processing unit may completely process the plurality of video processing components (S510). In other words, the video signal may be processed through all of the plurality of video processing components.

The video delay time may be identically maintained (S520), and the video frame may be output while maintaining the video delay time (S550). In other words, since the difference in delay time is maintained, the video and the graphics may be output without synchronization, which may cause noise.

When the size of the video frame is less than or equal to the reference size (YES of S500), the main processing unit may calculate the difference in delay time, which is a difference between the video delay time and the graphics delay time (S530).

The main processing unit may perform partial processing by omitting at least one of the plurality of video processing components (S540). Referring to FIG. 5, the main processing unit may omit at least one of the plurality of video processing components included in the video quality block and the FRC quality block.

The omitted component may be determined by the difference in delay time, and frame delay required in the omitted component and the difference in delay time may be identical to each other. That is, the video delay time may be shortened by the difference in delay time (S550). The video frame may be output at the shortened video delay time (S560). That is, since there is no difference in delay time, the video and the graphics may be synchronized and output.

The processes S500 to S560 may be repeatedly performed until the output of the video and the graphics is terminated.

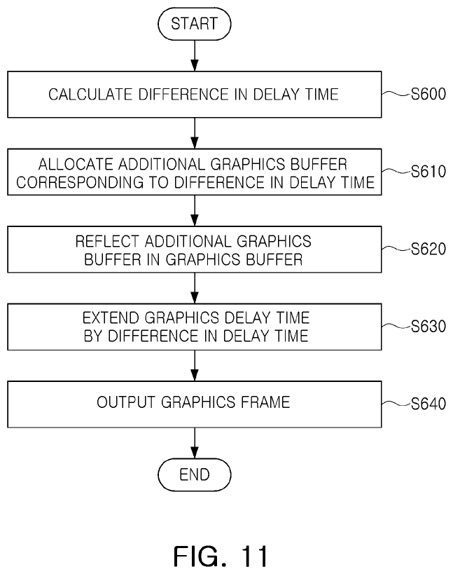

FIG. 11 is a flow chart illustrating an example of a process of compensating a graphics delay time according to some implementations. In FIG. 11, a display apparatus may include a video processing unit, a graphics processing unit, a mixing unit, a display unit, a memory unit and a main processing unit. The memory unit may include a video buffer for storing the video signal processed by the video processing unit, and a graphics buffer for storing the graphics signal processed by the graphics processing unit.

The video signal and the graphics signal may be processed for each frame according to a vertical synchronization signal. The video buffer and the graphics buffer may be in a format of storing frames processed in a first-in, first-out (FIFO) structure. That is, the video frame and the graphics frame may be sequentially stored in the video buffer and the graphics buffer and may then be output. Accordingly, when a buffer is added, the frame delay may increase until the stored frame is output.

FIG. 11 may correspond to a process of extending the graphics delay time by reflecting an additional graphics buffer in the graphics buffer.

The main processing unit may calculate the difference in delay time, which is a difference between the video delay time and the graphics delay time (S600). The main processing unit may allocate an additional graphics buffer corresponding to the difference in delay time (S610). In other words, the frame delay and the difference in delay time required in the additional graphics buffer may be identical to each other.

The main processing unit may reflect the additional graphics buffer in the graphics buffer (S620), and the graphics delay time may extend by the difference in delay time (S630). The graphics frame may be output with at the extending graphics delay time (S640). That is, since there is no difference in delay time, the video and the graphics may be synchronized and output.

The processes S600 to S640 may be repeatedly performed until the output of the video and the graphics is terminated.

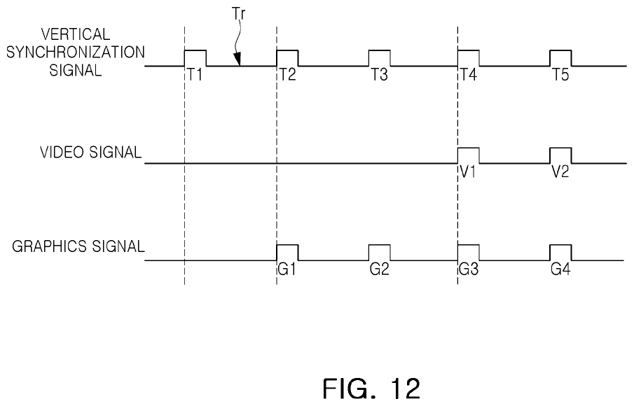

FIGS. 12 to 14 are views illustrating examples of a vertical synchronization signal, a video signal, and a graphics signal according to some implementations. In FIGS. 12 to 14, a display apparatus may process each of the video signal and the graphics signal for each frame according to a synchronization signal. In this case, the synchronization signal may be a vertical synchronization signal for the display unit.

In FIGS. 12 to 14, a rendering request time Tr at which rendering is requested for each of the video signal and the graphics signal may be identical to each other. The rendering request time Tr may correspond to an interval between a first pulse time T1 and a second pulse time T2 of the vertical synchronization signal.

First, FIG. 12 may illustrate a video signal and a graphics signal of a display apparatus in which the video delay time and the graphics delay time are not compensated.

The graphics signal may be processed in the graphics processing unit, and a first graphics frame G1 may be output to the display unit at the second pulse time T2 of the vertical synchronization signal. The graphics delay time may be the time from the rendering request time Tr to the second pulse time T2. The video signal may be processed in the video processing unit, and a first video frame V1 may be output to the display unit at a fourth pulse time T4 of the vertical synchronization signal. The video delay time may be the time from the rendering request time Tr to the fourth pulse time T4.

A difference between the video delay time and the graphics delay time may be calculated as the difference in delay time. In FIG. 12, the time from the first pulse time T1 to the fourth pulse time T4 of the vertical synchronization signal may be the difference in delay time. The video delay time may be longer than the graphics delay time.

The number of the plurality of video processing components may be greater than the number of the plurality of graphics processing components. Accordingly, the frame delay required by the plurality of video processing components may be longer than the frame delay required by the plurality of graphics processing components. In other words, the video and the graphics may be output without synchronization, which may cause noise.

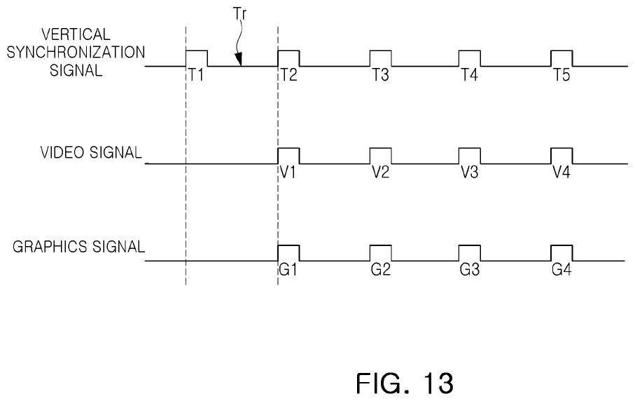

FIG. 13 may illustrate examples of a video signal and a graphics signal of a display apparatus for performing compensation of shortening the video delay time. In FIG. 9 and FIG. 10, the video delay time may be shortened based on the geometry information of the plurality of video frames.

In FIG. 13, the display apparatus may shorten the video delay time by the difference in delay time by omitting at least one of the plurality of video processing components. Accordingly, the first video frame V1 and the first graphics frame G1 may be output to the display unit at the second pulse time T2 of the vertical synchronization signal. That is, the video and the graphics may be synchronized and output.

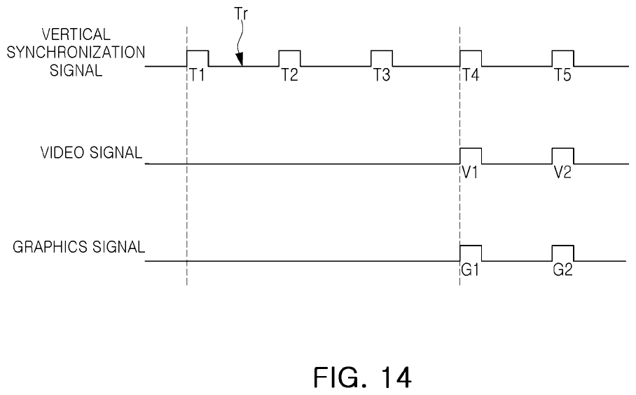

FIG. 14 may illustrate examples of a video signal and a graphics signal of a display apparatus for performing compensation of extending the graphics delay time. In FIG. 11, the graphics delay time may extend based on the difference in delay time.

In FIG. 14, the display apparatus may allocate an additional graphics buffer corresponding to the difference in delay time, may reflect the additional graphics buffer in the graphics buffer, and may extend the graphics delay time by the difference in delay time. Accordingly, the first video frame V1 and the first graphics frame G1 may be output to the display unit at the fourth pulse time T4 of the vertical synchronization signal. That is, the video and the graphics may be synchronized and output.

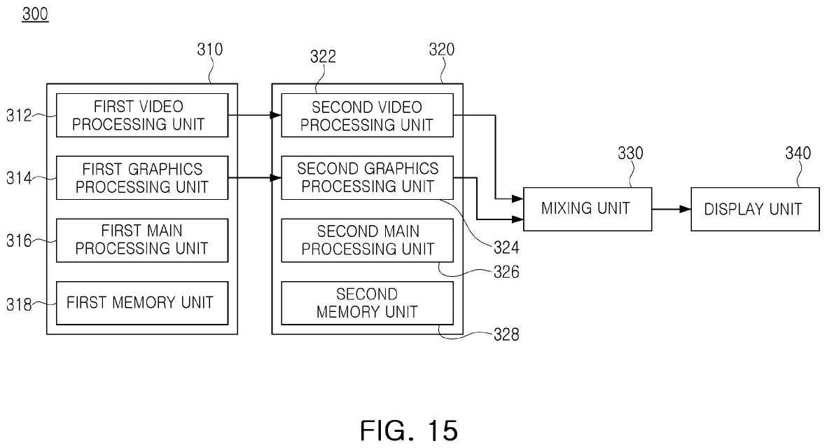

FIG. 15 is a block diagram schematically illustrating an example configuration of a display apparatus according to some implementations. In FIG. 15, a display apparatus 300 may include a first semiconductor chip 310, a second semiconductor chip 320, a mixing unit 330, and a display unit 340. The display apparatus 300 may further include an interface unit and a user input unit.

The first semiconductor chip 310 and the second semiconductor chip 320 may be display driving apparatuses for driving the display apparatus 300. The first semiconductor chip 310 is a mobile application processor (Mobile AP), which may be provided in the form of a system on chip (SoC). The second semiconductor chip 320 may be provided in the form of a digital television system on chip (DTV SoC).

The first semiconductor chip 310 may include a first video processing unit 312, a first graphics processing unit 314, a first main processing unit 316, and a first memory unit 318. The first video processing unit 312 may process a video signal, and the first graphics processing unit 314 may process a graphics signal. The first main processing unit 316 may control the first video processing unit 312 and the first graphics processing unit 314. The first memory unit 318 may include a first video buffer for storing a processed video signal and a first graphics buffer for storing a processed graphics signal.

The second semiconductor chip 320 may include a second video processing unit 322, a second graphics processing unit 324, a second main processing unit 326, and a second memory unit 328. The second video processing unit 322 may process the video signal processed by the first video processing unit 312. The second graphics processing unit 324 may process the graphics signal processed by the first graphics processing unit 314. The second main processing unit 326 may control the second video processing unit 322 and the second graphics processing unit 324. The second memory unit 328 may include a second video buffer for storing a processed video signal and a second graphics buffer for storing a processed graphics signal.

In some implementations, the first semiconductor chip 310 may receive a rendering request from an application. The application may transmit video geometry information for expressing the video and graphics geometry information for expressing the graphics to the first main processing unit 316.

The first main processing unit 316 may calculate the video delay time for each of a plurality of video frames using the video rendering request time at which rendering is requested for each of the plurality of video frames of the video signal and the video output time at which each of the plurality of video frames is output to the display unit.

The first main processing unit 316 may calculate the graphics delay time for each of a plurality of graphics frames using the graphics rendering request time at which rendering is requested for each of the plurality of graphics frames of the graphics signal and the graphics output time at which each of the plurality of graphics frames is output to the display unit.

The first main processing unit 310 and the second main processing unit 320 may shorten the video delay time by omitting at least portions of the plurality of first video processing components included in the first video processing unit 312 and the plurality of second video processing components included in the second video processing unit 322.

The first main processing unit 316 may allocate an additional graphics buffer corresponding to the difference in delay time, which is a difference between the video delay time and the graphics delay time. The first main processing unit 310 and the second main processing unit 320 may extend the graphics delay time by allocating an additional graphics buffer to at least one of the first graphics buffer and the second graphics buffer. In other words, a graphics buffer may be added to at least one of the first graphics buffer and the second graphics buffer.

In some implementations, the first main processing unit 316 may extend the graphics delay time by reflecting the additional graphics buffer to the first graphics buffer. Then, the graphics signal having the extending graphics delay time may be transmitted from the first graphics processing unit 314 to the second graphics processing unit 324 via a display port.

In some implementations, the graphics signal may be transmitted from the first graphics processing unit 314 to the second graphics processing unit 324 via the display port. Then, the second main processing unit 326 may extend the graphics delay time by reflecting the additional graphics buffer to the second graphics buffer.

In some implementations, a portion of the additional graphics buffer may be reflected in the first graphics buffer, and another portion of the additional graphics buffer may be reflected in the second graphics buffer. In other words, the first main processing unit 316 may extend a portion of the graphics delay time by reflecting a portion of the additional graphics buffer in the first graphics buffer. The graphics signal having the extending graphics delay time may be transmitted to the second graphics processing unit 324 via the display port. The second main processing unit 326 may extend a portion of the graphics delay time by reflecting another portion of the additional graphics buffer in the second graphics buffer.

The first main processing unit 316 may shorten the video delay time by the difference in delay time based on the geometry information of the plurality of video frames.

In some implementations, the first main processing unit 316 may shorten the video delay time by the difference in delay time by omitting at least one of the plurality of first video processing components included in the first video processing unit 312. The video signal having the shortened video delay time may be transmitted to the second video processing unit 322 through the display port.

In some implementations, the video signal may be transmitted from the first video processing unit 312 to the second video processing unit 322 through the display port. Then, the second main processing unit 326 may shorten the video delay time by the difference in delay time by omitting at least one of the plurality of second video processing configurations included in the second video processing unit 322.

In some implementations, the first main processing unit 316 may shorten the video delay time by a portion of the difference in delay time by omitting at least one of the plurality of first video processing components included in the first video processing unit 312. The video signal having the shortened video delay time may be transmitted to the second video processing unit 322 via the display port. The second main processing unit 326 may shorten the video delay time by another portion of the difference in delay time by omitting at least one of the plurality of second video processing components included in the second video processing unit 322.

The mixing unit 330 may mix the video frame provided from the second video processing unit 322 and the graphics frame provided from the second graphics processing unit 324. The mixed video frame and graphics frame may be output to the display unit 340. Accordingly, the corresponding video frames and the corresponding graphics frames may be synchronized and sequentially output to the display unit 340.

While this disclosure contains many specific implementation details, these should not be construed as limitations on the scope of what may be claimed, equivalents thereof, as well as claims to be described later. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

What is claimed is:

1. A display apparatus, comprising:
a video processor configured to process a video signal;
a graphics processor configured to process a graphics signal;
a mixing processor configured to mix the processed video signal and the processed graphics signal to provide a mixed video and graphics signal;
a display device configured to output the mixed video and graphics signal; and
a main processor configured to control the video processor, the graphics processor, the mixing processor, and the display device,
wherein the video signal includes a plurality of video frames, and the graphics signal includes a plurality of graphics frames, and
wherein the main processor is configured to
calculate, for each video frame of the plurality of video frames, a respective video delay time using both a video rendering request time at which rendering is requested for the video frame and a video output time at which the video frame is output to the display device,
calculate, for each graphics frame of the plurality of graphics frames, a respective graphics delay time using both a graphics rendering request time at which rendering is requested for the graphics frame and a graphics output time at which the graphics frame is output to the display device, and
synchronize the plurality of video frames and the plurality of graphics frames by compensating at least one video delay time, at least one graphics delay time, or at least one video delay time and at least one graphics delay time.

2. The display apparatus of claim 1,
wherein, for each video frame, the respective video delay time is a time from the video rendering request time for the video frame to the video output time for the video frame, and
wherein, for each graphics frame, the respective graphics delay time is a time from the graphics rendering request time for the graphics frame to the graphics output time for the graphics frame.

3. The display apparatus of claim 1, wherein the main processor is configured to store the video rendering request time and the graphics rendering request time in context data.

4. The display apparatus of claim 1, wherein the main processor is configured to:
insert an output order of the plurality of video frames into each video frame of the plurality of video frames as a video binarization pattern, and calculate the video rendering request time by analyzing the video binarization pattern; and
insert an output order of the plurality of graphics frames into each graphics frame of the plurality of graphics frames as a graphics binarization pattern, and calculate the graphics rendering request time by analyzing the graphics binarization pattern.

5. The display apparatus of claim 1,
wherein the video processor includes a plurality of video processing components,
wherein the graphics processor includes a plurality of graphics processing components, and
wherein a number of the plurality of video processing components is greater than a number of the plurality of graphics processing components.

6. The display apparatus of claim 5, wherein, for at least one of the plurality of video frames, the video delay time is longer than the graphics delay time.

7. The display apparatus of claim 5, wherein the main processor is configured to:
calculate a first video-graphics delay time, wherein the video-graphics delay time is a difference between a first video delay time and a first graphics delay time; and
compensate the first video delay time, the first graphics delay time, or both the first video delay time and the first graphics delay time based on the video-graphics delay time.

8. The display apparatus of claim 7, wherein the main processor is configured to compensate the first video delay time based on geometry information from the plurality of video frames.

9. The display apparatus of claim 8, wherein the geometry information includes sizes and positions of each video frame of the plurality of video frames.

10. The display apparatus of claim 9, wherein the main processing unit is configured to:
calculate a change frequency of the geometry information of the plurality of video frames; and
shorten the first video delay time when the change frequency of the geometry information is greater than or equal to a reference frequency.

11. The display apparatus of claim 10, wherein the main processor is configured to shorten the first video delay time by the video-graphics delay time by implementing less than all of the plurality of video processing components.

12. The display apparatus of claim 9, wherein the main processor is configured to shorten the first video delay time based on sizes of the plurality of video frames being less than or equal to a reference size.

13. The display apparatus of claim 12, wherein the main processor is configured to shorten the first video delay time by the video-graphics delay time by implementing less than all of the plurality of video processing components.

14. The display apparatus of claim 7, further comprising:
a memory circuit that includes a video buffer configured to store a video signal processed by the video processor and a graphics buffer configured to store a graphics signal processed by the graphics processor.

15. The display apparatus of claim 14, wherein the main processor is configured to allocate an additional graphics buffer corresponding to the video-graphics delay time, and include the additional graphics buffer in the graphics buffer to extend the graphics delay time.

16. A display apparatus, comprising:
a video processor configured to process a video signal including a plurality of video frames, the video processor including a plurality of video processing components;
a graphics processor configured to process a graphics signal that includes a plurality of graphics frames, the graphics processor including a plurality of graphics processing components;
a mixing processor configured to mix the processed video signal and the processed graphics signal to provide a mixed video and graphics signal;
a display device configured to output the mixed video and graphics signal; and
a main processor configured to control the video processor, the graphics processor, the mixing processor, and the display device,
wherein a number of the plurality of video processing components is greater than a number of the plurality of graphics processing components, and
wherein the main processor is configured to
shorten, for each of the plurality of video frames, a respective video delay time using a time at which each of the plurality of video frames is output to the display device, or
extend, for each graphics frame of the plurality of graphics frames, a respective graphics delay time using a time at which each of the plurality of graphics frames is output to the display device.

17. The display apparatus of claim 16, wherein, for at least one of the plurality of video frames, the video delay time is longer than the graphics delay time.

18. The display apparatus of claim 17, wherein the main processor is configured to: shorten the video delay time by the difference in delay time by implementing less than all of the plurality of video processing components, when a change frequency of geometry information of the plurality of video frames is greater than or equal to a reference frequency or sizes of the plurality of frames are lower than or equal to a reference size.

19. The display apparatus of claim 17, further comprising:
a memory circuit that includes a video buffer configured to store a video signal processed by the video processor and a graphics buffer configured to store the graphics signals processed by the graphics processor,
wherein the main processor is configured to allocate an additional graphics buffer corresponding to a difference in delay time, include the additional graphics buffer in the graphics buffer, and extend the graphics delay time.

20. A display driving apparatus, comprising:
a first semiconductor chip including a first video processor configured to process a video signal including a plurality of video frames, a first graphics processor configured to process a graphics signal including a plurality of graphics frames, a first main processor configured to control the first video processor and the first graphics processor, and a first memory circuit including a first video buffer configured for storing the processed video signal and a first graphics buffer for storing the processed graphics signal; and
a second semiconductor chip including a second video processor configured to process the processed video signal, a second graphics processor configured to process the processed graphics signal, a second main processor configured to control the second video processor and the second graphics processor, and a second memory circuit including a second video buffer configured to store the processed video signal and a second graphics buffer configured to store the processed graphics signal,
wherein the first main processor is configured to
calculate, for each of the plurality of video frames, a respective video delay time using a time at which each of the plurality of video frames is output, and
calculate, for each of the plurality of graphics frames, a respective graphics delay time using a time at which each of the plurality of graphics frames is output, and
wherein the first main processor and the second main processor are configured to
shorten the video delay time by omitting at least portions of a plurality of first video processing components included in the first video processor and a plurality of second video processing components included in the second video processor, or
extend the graphics delay time by including a graphics buffer to at least one of the first graphics buffer and the second graphics buffer.
